(19) United States
(12) Patent Application Publication
(10) Pub. No.: US 2025/0346086 A1
(43) Pub. Date: Nov. 13, 2025

(54) PRE-LOAD METHOD AND SYSTEM FOR BODY SPRING OF SNOW VEHICLE

(71) Applicant: Robert Bosch GmbH, Stuttgart (DE)

(72) Inventors: Kurt Person, Florence, WI (US); Naoto Kijima, Northville, MI (US); Shunsaku Ono, Novi, MI (US)

(21) Appl. No.: 18/656,962

(22) Filed: May 7, 2024

(51) Int. Cl. B60G 17/018; B60G 17/019; B62M 27/02

(52) U.S. Cl. CPC B60G 17/018; B60G 17/01908; B60G 17/01941; B62M 27/02; B60G 2300/322; B60G 2400/10; B60G 2500/20; B62M 2027/026

(57) ABSTRACT

A snow vehicle having a body spring subject to a load compression dictated by a control circuit. The control circuit generates a resultant load compression value by combining a pre-load compression value and a slope offset value. The pre-load compression value may be controlled by a pre-load control mechanism accessible to a user. The slope offset value may be controlled by an inertial management unit responding to data generated by a sensor array. The sensor array may comprise an accelerometer and generate 6-dimensional accelerometer data.

### TECHNICAL FIELD

This disclosure relates to vehicular adjustment mechanisms. More specifically, this disclosure relates to a comfort control for a snowmobile.

### BACKGROUND

Snow vehicles, such as snowmobiles and snow bikes, are used on uneven terrain, including inclines and declines that may have substantial gradients. Inexperienced riders may not feel comfortable riding on sufficiently steep gradients. A reduction of the incline as experienced by the rider can make the ride more comfortable, particularly for inexperienced riders. What is desired is a mechanism to permit the rider to adjust the range of inclines experienced during motion, including options for the comfort of riders of differing skill and experience.

### SUMMARY

One aspect of this disclosure is directed to a method of loading a body spring of a snow vehicle. The method comprises generating a pre-load compression value for the body spring based upon the status of a pre-load indicator, generating a slope signal in response to the output of an accelerometer, generating a slope offset value based upon the slope signal, and applying a resultant load to the body spring, the resultant load equaling the combination of the pre-load compression value and the slope offset value. The pre-load indicator may be determined by the position of a switch. In some embodiments, the slope offset value will be inverse to the gradient experienced by the rider.

Another aspect of this disclosure is directed to a control system of a snow vehicle comprising a control circuit having a first output to control a braking mechanism of the snow vehicle and a second output to control a pre-load compression of a body spring of the snow vehicle, an inertial measurement unit having a sensor and in data communication with the control circuit, a pre-load indicator switch indicating a pre-load condition of the body spring, and a load adjuster configured to apply a compressive load to the body spring in response to a signal from the second output. The load adjuster applies a pre-load compression of the body spring responsively to the extant conditions according to a signal of the second output of the control circuit. In some embodiments, the sensor is an accelerometer.

A further aspect of this disclosure is directed to a control system of a snow vehicle comprising a control circuit having an output to control a pre-load compression of a body spring of the snow vehicle, an inertial measurement unit having a sensor and in data communication with the control circuit, a pre-load indicator switch indicating a pre-load condition of the body spring, and a load adjuster configured to apply a compressive load to the body spring in response to a signal from the output. The load adjuster applies a pre-load compression of the body spring responsively to the extant conditions according to a signal of the output of the control circuit. In some embodiments, the output is a hydraulic control output.

The above aspects of this disclosure and other aspects will be explained in greater detail below with reference to the attached drawings.

### BRIEF DESCRIPTION OF THE DRAWINGS

FIG. 1 is a diagrammatic view of a snow vehicle having a pre-load control system.

FIG. 2 is a diagrammatic illustration of a control system of a snow vehicle.

FIG. 3A is an illustration of a pre-load adjuster under a first load.

FIG. 3B is an illustration of a pre-load adjuster under a second load.

FIG. 4 is a diagrammatic illustration of a snow vehicle operating in a first pre-load condition.

FIG. 5 is a diagrammatic illustration of a snow vehicle operating in a second pre-load condition.

FIG. 6 is a diagrammatic illustration of a snow vehicle operating in a third pre-load condition.

FIG. 7 is a flowchart illustrating a method of loading a body spring of a snow vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

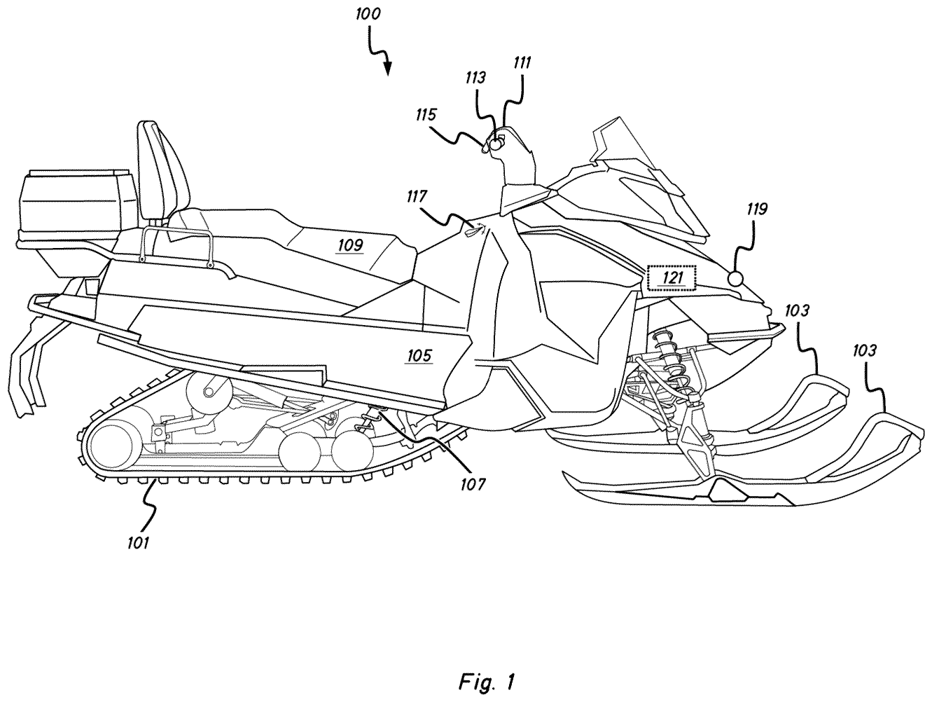

FIG. 1 is a diagrammatic illustration of a snow vehicle 100 having features for permitting a rider to adjust the riding experience for their comfort. In the depicted embodiment, snow vehicle 100 is a snowmobile 100, but other embodiments may comprise other configurations without deviating from the teachings disclosed herein.

Snowmobile 100 comprises a tread 101 suitable to propel the snowmobile 100, skis 103 suitable to stabilize and help turn the snowmobile 100, and a body 105 which supports a rider or riders and houses functional components of snowmobile 100. To maximize comfort of the rider, the position of body 105 relative to the tread 103 may be adjusted via a body spring 107, which can be loaded with expansion or compression of body spring 107 to accommodate for tilt of snowmobile 100 on inclined terrain. Body 105 comprises a saddle 109 that supports a rider, and adjustment of the relative angle of the body 105 with respect to the tread 101 can result in a more comfortable experience for the rider.

Body 105 additionally provides other user-related functions, including a steering control 111, a throttle 113, a brake control 115 and a pre-load control 117. Steering control 111 permits a user to steer the forward direction of snowmobile 100 by adjusting the angle of skis 103 relative to the tread 101. In the depicted embodiment, steering control 111 comprises a handlebar stem, but other embodiments may comprise other configurations of a steering control without deviating from the teachings disclosed herein.

Throttle 113 permits a user to engage a motor (not shown) that rotates tread 101, providing propulsion of snowmobile 100. In the depicted embodiment, throttle 113 comprises a thumb operated lever throttle on a right-hand side of steering control 111, but other embodiments may comprise other configurations without deviating from the teachings disclosed herein.

Brake control 115 permits a user to slow or prevent rotation of tread 101, creating potential friction between snowmobile 100 and a surface upon which it traverses. In the depicted embodiment, brake control 115 comprises handlebar lever on a left-hand side of steering control 111, but other embodiments may comprise other configurations without deviating from the teachings disclosed herein. In the depicted embodiment, brake control 115 activates a brake rotor (not shown) that engages with tread 101, but other embodiments may comprise other braking mechanisms without deviating from the teachings disclosed herein. In the depicted embodiment, brake control 115 comprises a hydraulic braking control, but other embodiments may comprise different configurations, such as electronic braking, manual braking, pneumatic braking, or any other configuration recognized by one of ordinary skill without deviating from the teachings disclosed herein.

In the depicted embodiment, the body spring 107 may be pre-loaded with a compression value dictated by pre-load control 117. In embodiments where body spring 107 is chosen to exhibit nonlinear compression characteristic, pre-load compression advantageously compresses body spring 107 with a predetermined amount of force. Body spring 107 exhibits different compression characteristics when compressed compared to when it is uncompressed, which advantageously increases the amount of force necessary to compress the spring further. This pre-load of the spring advantageously reduces the total possible compression of the body spring 107 during motion, meaning the change in the relative angle of the body 105 and tread 101 is minimized. This additionally advantageously has a “smoothing” effect upon the ride for the rider that scales upward as additional pre-load compression is applied to body spring 107. For this reason, pre-load control 117 may be configured to exert a range of pre-load compression values upon body spring 107, with different pre-load compression values corresponding to different riding conditions which may be selected by the rider. In the depicted embodiment, pre-load control 117 comprises multi-positional switch, but other embodiments may comprise other configurations for selecting desired pre-load compression value. By way of example, and not limitation, such alternative embodiments may comprise a radial dial, digital encoder, electric potentiometer, a button or array of buttons, an array of selector switches, or any other control mechanism known to one of ordinary skill in the art without deviating from the teachings disclosed herein.

Snowmobile 100 additionally comprises a sensor 119 and an adjustment unit 121 to provide data and controls for the optimization of the compression of body spring 107. Sensor 119 monitors an operating condition of snowmobile 100 and generates data indicating conditions to adjustment unit 121. In the depicted embodiment, sensor 119 comprises at least one accelerometer suitable to determine multi-dimensional motion experienced by snowmobile 100, including motion influenced by the terrain upon which snowmobile 100 traverses. In the depicted embodiment, sensor 119 may comprise a 6-dimensional accelerometer array, suitable to measure motion in 3 dimensions of linear motion and 3 dimensions of rotational motion. The output of sensor 119 may comprise 6-dimensional sensor data that is utilized by adjustment unit 121 to detect if snowmobile 100 is operating on a gradient, such as an incline or decline.

In response to determining that snowmobile 100 is operating on a gradient, adjustment unit 121 may generate a slope offset value indicating an amount of compression to be applied to body spring 107. In the depicted embodiment, body spring 107 is oriented such that body 105 pitches downward relative to tread 101 when body spring 107 is extended, and body 105 pitches upward relative to tread 101 when body spring 107 is compressed. Other embodiments may comprise a differently oriented body spring 107 without deviating from the teachings disclosed herein, but in such embodiments the compression of the body spring 107 will have a different affect on the orientation of body 105 without deviating from the teachings disclosed herein.

By way of example and not limitation, other embodiments may comprise a snow vehicle 100 having the form of a snow bike without deviating from the teachings disclosed herein. For the purposes of this disclosure, a snow bike has the general form of an offroad motorcycle, providing a rider with an upright position and is steered using a throttled handlebar control. In some such embodiments, a snow bike may comprise a modified offroad motorcycle having a front wheel replaced by a ski (such as a ski 103) and a rear wheel replaced with a snow track tread suitably shaped to replace a wheel. Other embodiments may comprise other configurations without deviating from the teachings disclosed herein.

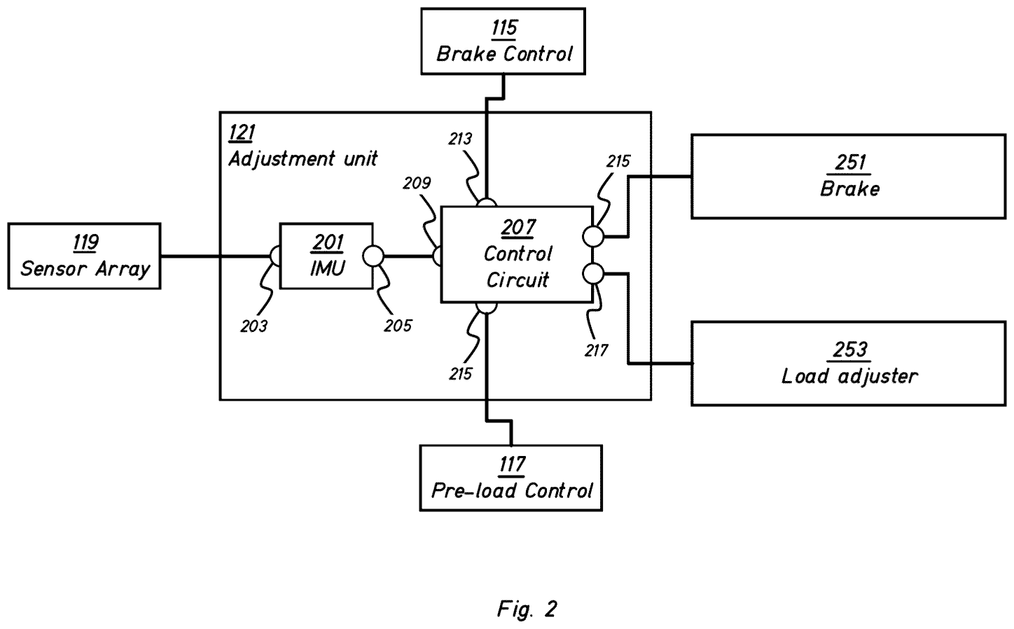

FIG. 2 is diagrammatic illustration of a control system of a snow vehicle (such as snow vehicle 100; see FIG. 1). The control system is driven principally by adjustment unit 121 which comprises an inertial management unit (IMU) 201 having an input 203 and an output 205, and a control circuit 207 having a number of inputs 209, 211, and 213, and a number of outputs 215 and 217.

IMU 201 receives data from sensor array 119 and generates a slope offset value to be passed to control circuit 207. The slope offset value is generated based upon the data received from the sensor array 119. The data is generated responsively to extant conditions of the associated snow vehicle. In the depicted embodiment, the slope offset value will comprise a positive value to indicate when a body spring should be compressed (such as to compensate for traversal of an incline) and a negative value to indicate when the body spring should be relieved (such as to compensate for traversal of a decline). The slope offset value will be zero to indicate when the body spring needs no offset to accommodate for an incline. In the depicted embodiment, when the sensor array 119 generates data indicating a gradient having an absolute value below a threshold value, the slope offset value will be set to zero. By of example, and not limitation, the depicted embodiment may have a threshold value of a one-percent gradient of incline or decline. Other embodiments may comprise other configurations without deviating from the teachings disclosed herein. In the depicted embodiment, body spring 107 is oriented with respect to the rest of snow vehicle 100 such that these correlations are appropriate, but other embodiments having other orientations of body spring 107 may utilize different correlations without deviating from the teachings disclosed herein.

Different pre-load compressions may be applied to a body spring 107 in response to a status of a pre-load control 117. In the depicted embodiment, pre-load control 117 comprises a switch having three distinct positions, each of the positions corresponding to a different pre-load compression setting. In the depicted embodiment, the three conditions may correspond to “OFF,” “LOW,” and “HIGH” pre-load settings, which each correspond to a different pressure applied to body spring 107. By way of example, and not limitation, the OFF setting may apply 0 bar of pressure (i.e., no pre-load compression of the body spring), the LOW setting may apply 25 bar of pressure, and the HIGH setting may apply 30 bar of pressure. Other embodiments may have additional or different configurations without deviating from the teachings disclosed herein. In some such embodiments, pre-load control 117 may comprise a dial suitable to set a range of pre-load compression values from a minimum (e.g., 0 bar; an OFF condition) to a maximum value (e.g., 35 bar; a “HIGH” condition)

The system additionally comprises a number of other components of the snow vehicle, including a sensor array 119, brake control 115, and pre-load control 117 (see FIG. 1). Adjustment unit 121 is additionally configured to interact with a brake 251, and a load adjuster 253 of the snow vehicle. Brake 251 is configured to engage with the locomotive element of the associated snow vehicle, such as tread 101 (see FIG. 1). In the depicted embodiment, brake 251 is a hydraulic brake, and control circuit output 215 is a hydraulic output, but other embodiments may comprise other configurations, such as an electrically controlled brake, without deviating from the teachings disclosed herein. In the depicted embodiment, control circuit 207 utilizes input from brake control 115 via input 213 to selectively engage brake 251 according to user control. Some embodiments of adjustment unit 121 may not comprise a braking path without deviating from the teachings disclosed herein. In such embodiments, control circuit 207 would not comprise input 213 or output 215 without deviating from the teachings disclosed herein.

Load adjuster 253 is a mechanical unit that applies a compressive load to a body spring of the associated snow vehicle (such as body spring 107, see FIG. 1) according to a signal provided from control circuit output 217. Control circuit 207 utilizes the inputs provided by IMU 201 and pre-load control 117 to formulate a resultant load value to be applied to the body spring. In the depicted embodiment, load adjuster 253 comprises a hydraulic engagement, and control circuit 207 generates a hydraulic signal to be passed via output 217. Other embodiments may comprise other configurations of load adjuster 253, such as an electrically controlled adjuster, without deviating from the teachings disclosed herein. Control circuit 207 utilizes information from IMU 201, but also a pre-load indicator supplied by pre-load control 117 (see FIG. 1) to generate a resultant load to be applied to the body spring 107. The resultant load will be a combination of the pre-load compression value according to the pre-load control 117 and the slope offset value according to the IMU 201.

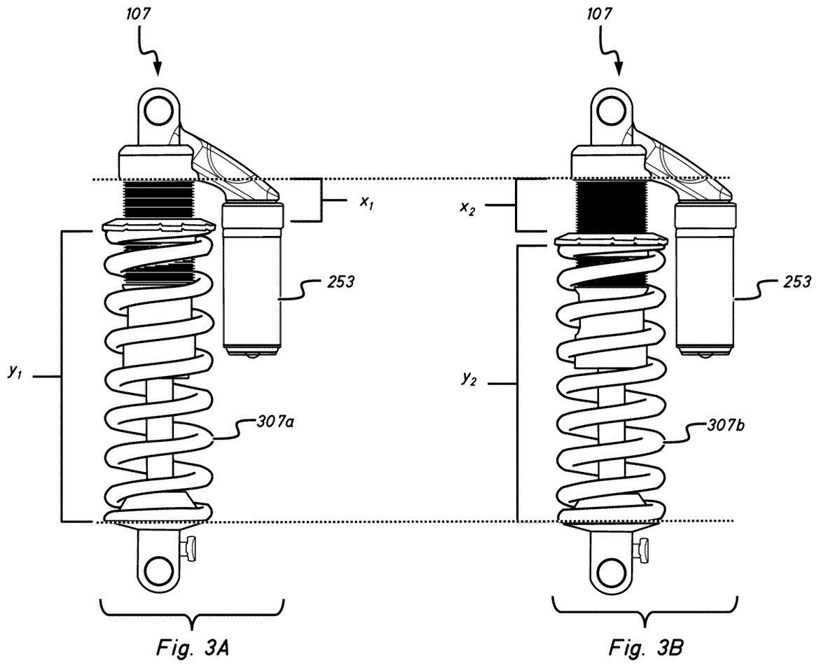

FIG. 3A and FIG. 3B are illustrative of a pre-load compression being applied to a body spring 107 by a load adjuster 253. In FIG. 3A, a spring component 307a of body spring 107 is displaced by a first distance of x₁ while being subject to a first pre-load compression by load adjuster 253. This displacement leaves a first remainder distance y₁ for spring component 307a to possibly traverse under load. In contrast, in FIG. 3B, a second pre-load compression has been applied by load adjuster 253 that is greater than the pre-load compression applied in FIG. 3A. As a result, spring component 307b has displaced a greater distance x₂, leaving a shorter remainder distance y₂. In this depiction, spring component 307a is identical to spring component 307b, but each depiction is subjected to a different pre-load compression.

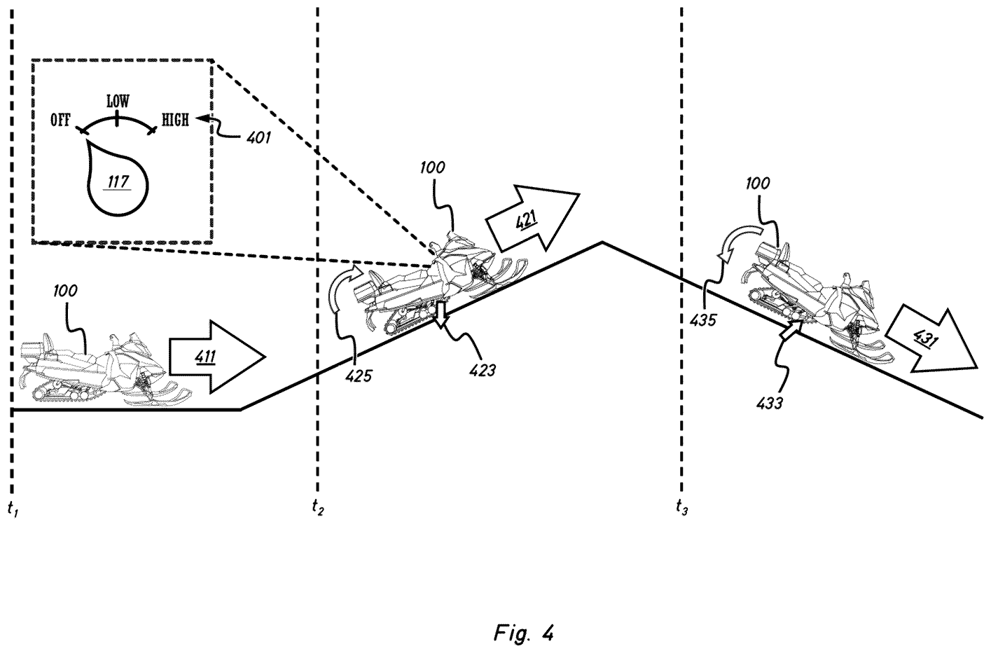

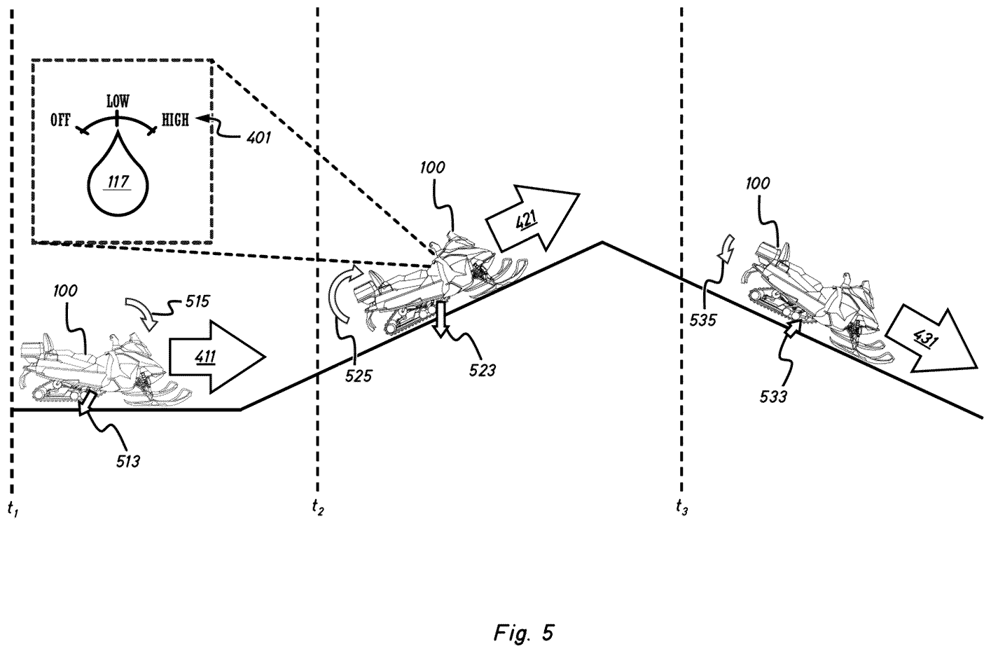

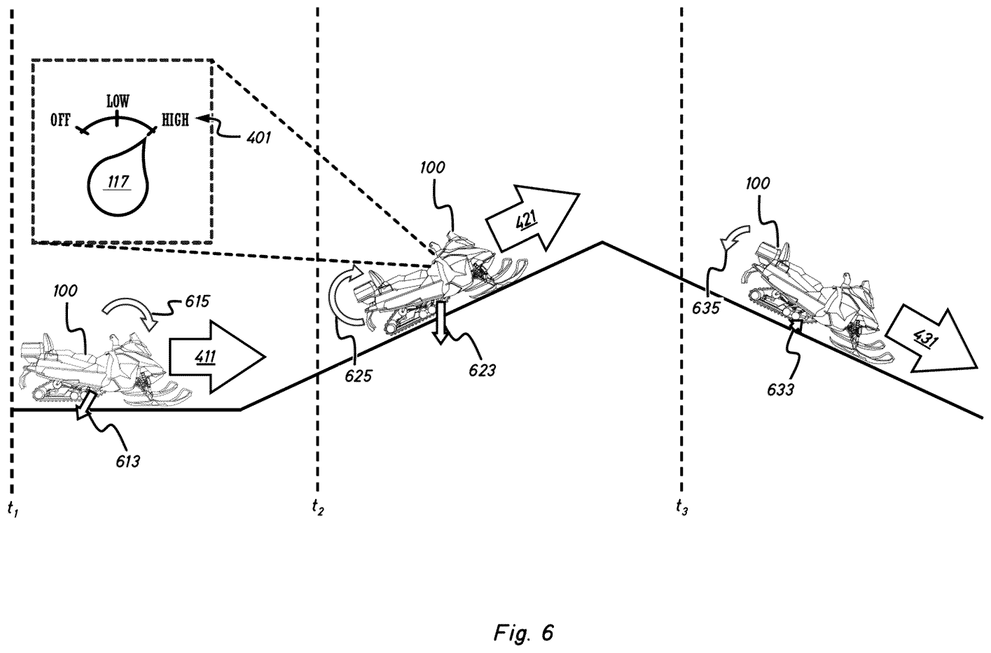

FIG. 4, FIG. 5, and FIG. 6 are illustrations of a snow vehicle 100 (here represented as snowmobile 100; see FIG. 1) operating in various pre-load conditions. The operating state of the snow vehicle 100 is selectable and observable based upon the position of pre-load control 117, depicted here as a 3-position switch that aligns with a pre-load display 401.

In FIG. 4, the pre-load control 117 is set to the OFF condition, and thus there is no pre-load compression applied to the body spring (such as body spring 107; not shown; see FIG. 1). This operating condition is most similar to conventional operation of a snow vehicle that does not have pre-load functions.

At a first time t₁, snow vehicle 100 in FIG. 4 experiences a propulsive force 411 while traversing across terrain that exhibits no significant gradient. During this operation, no additional compression is applied to the body spring.

Later at time t₂, snow vehicle 100 traverses an incline while experiencing propulsive force 421, which includes a component of upward force orthogonal to the incline surface. In order to compensate for this, a slope offset is generated to compress the body spring with a slope offset compression force 423. This slope offset compression tilts the body of snow vehicle 100 along a rotational axis 425, resulting in a downward orientation of the body with respect to the tread, providing a more neutral riding position for a rider.

Conversely, at the later time t₃, snow vehicle 100 is experience a propulsive force 431 while traversing a decline. To compensate for the decline, a slope offset is generated to reduce the compression of the body spring with a corresponding slope offset expansion force 433. This slope offset expansion tilts the body of snow vehicle 100 along a rotational axis 435, resulting in an upward orientation of the body with respect to the tread, providing a more neutral riding position for a rider.

In FIG. 5, the pre-load control 117 is set to the LOW condition, and thus there is a pre-load compression force 513 applied to the body spring (such as body spring 107; not shown; see FIG. 1).

At a first time t₁, snow vehicle 100 in FIG. 5 experiences the propulsive force 411 while traversing across terrain that exhibits no significant gradient. During this operation, no additional compression is applied to the body spring, so only the pre-load compression force 513 is present. Because of the pre-load compression force application, there is downward tilt of the body 515 experienced by the rider.

Later at time t₂, snow vehicle 100 traverses an incline while experiencing propulsive force 421, as before. In order to compensate for the upward force orthogonal to the surface, thus, slope offset compression force 423 (see FIG. 4) is again generated and applied to the body spring. However, because the pre-load compression force 513 is also applied, a resultant load 523 is generated and applied to the body spring. Resultant load 523 is a combination of the pre-load compression force and the slope offset compression force. In the depicted embodiment, this combination is a summation of the two forces, but other embodiments may comprise other configurations without deviating from the teachings disclosed herein. The resultant load 523 tilts the body of snow vehicle 100 along a rotational axis 525, resulting in a greater downward orientation of the body with respect to the tread, providing a similar riding position for a rider as before at t₁, even while traversing the incline.

Conversely, at the later time t₃, snow vehicle 100 is experiencing the propulsive force 431 while traversing a decline. Once again, a slope offset is generated in response to the decline to reduce the compression of the body spring with a corresponding slope offset expansion force 433 (see FIG. 4). However, this slope offset expansion force 433 is combined with the pre-load compression force 513, and a resultant load 533 is applied to the body spring. In the depicted embodiment, this combination is a summation of the two forces, but other embodiments may comprise other configurations without deviating from the teachings disclosed herein. The resultant compression force 533 tilts the body of snow vehicle 100 along a rotational axis 535, resulting in a greater upward orientation of the body with respect to the tread, providing a similar riding position for a rider as before at t₁, even while traversing the decline.

In FIG. 6, the pre-load control 117 is set to the HIGH condition, and thus there is a pre-load compression force 613 applied to the body spring (such as body spring 107; not shown; see FIG. 1).

At a first time t₁, snow vehicle 100 in FIG. 6 experiences the propulsive force 411 while traversing across terrain that exhibits no significant gradient. During this operation, no additional compression is applied to the body spring, so only the pre-load compression force 613 is present. Because of the pre-load compression force application, there is downward tilt of the body 615 experienced by the rider. In the HIGH operating condition, pre-load force 613 is necessarily greater than pre-load force 513 (see FIG. 5), resulting in a greater rotational tilt 615, but also an even smoother ride experience for the rider during operation.

Later at time t₂, snow vehicle 100 traverses an incline while experiencing propulsive force 421, as before. In order to compensate for the upward force orthogonal to the surface, thus, slope offset compression force 423 (see FIG. 4) is again generated and applied to the body spring. However, because the pre-load compression force 613 is also applied, a resultant load 623 is generated and applied to the body spring. Resultant load 623 is a combination of the pre-load compression force and the slope offset compression force. In the depicted embodiment, this combination is a summation of the two forces, but other embodiments may comprise other configurations without deviating from the teachings disclosed herein. The resultant load 623 tilts the body of snow vehicle 100 along a rotational axis 625, resulting in an even greater downward orientation of the body with respect to the tread when compared to previous operating conditions. This provides a similar riding position for a rider as before at t₁, even while traversing the incline.

Conversely, at the later time t₃, snow vehicle 100 is experiencing the propulsive force 431 while traversing a decline. Once again, a slope offset is generated in response to the decline to reduce the compression of the body spring with a corresponding slope offset expansion force 433 (see FIG. 4). However, this slope offset expansion force 433 is combined with the pre-load compression force 613, and a resultant load 633 is applied to the body spring. In the depicted embodiment, this combination is a summation of the two forces, but other embodiments may comprise other configurations without deviating from the teachings disclosed herein. The resultant load 623 tilts the body of snow vehicle 100 along a rotational axis 625, resulting in an upward orientation of the body with respect to the tread, providing a similar riding position for a rider as before at t₁, even while traversing the decline. Notably, the resultant load 633 is quite small, as the orientations of the pre-load compression and the slope offset expansion are largely applied in reverse directions. This results in a quite small body tilt along rotational axis 635 during the decline, in addition to the pre-load compression providing a maximally-smooth ride for the rider during operation.

Although FIG. 4, FIG. 5, and FIG. 6 each illustrate operation of a snow vehicle 100 under a single pre-load control condition, the rider is able to adjust the pre-load control 117 during operation to change pre-load behavior in real-time during operation. This advantageously permits a user to adjust the pre-load compression of the body spring “on-the-fly” in response to changing extant conditions, changes in passengers or cargo, or changes in other operating conditions while still achieving the best desired riding experience. Other embodiments may comprise other configurations without deviating from the teachings disclosed herein.

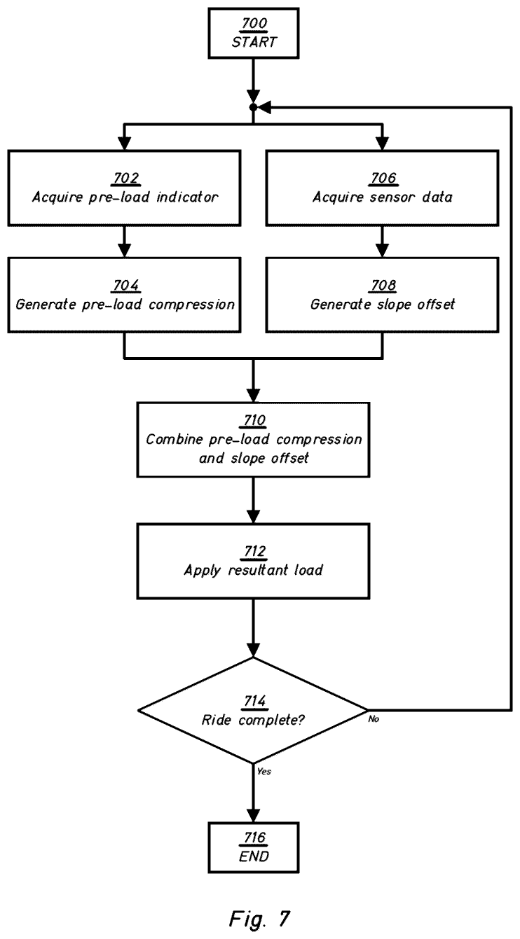

FIG. 7 is a flowchart illustrating a method of loading a body spring (such as body spring 107; see FIG. 1) of a snow vehicle (such as snow vehicle 100; see FIG. 1) according to an embodiment of the teachings disclosed herein. The method starts at step 700, which corresponds to the activation of the snow vehicle for operation. The method then proceeds to a two-stage concurrent operation that includes steps 702, 704, 706, and 708.

In step 702, a pre-load indicator is acquired for use in generation of a pre-load compression value at step 704. In the depicted embodiment, the pre-load indicator may be acquired from a switch, such as pre-load control 117 (see FIG. 1 and FIG. 4-5), but other embodiments may comprise other means to generate a pre-load control without deviating from the teachings disclosed herein. In the depicted embodiment, the switch may comprise a 3-position switch corresponding to pre-determined values of 0 bar, 25 bar, and 35 bar pre-load compression values respectively, but other embodiments may comprise other indicators or other controls without deviating from the teachings disclosed herein. In step 704 the generation of pre-load compression may be calculated by a control circuit (such as control circuit 207; see FIG. 2), but other embodiments may comprise other means without deviating from the teachings disclosed herein.

In step 706, sensor data is acquired indicating extant conditions of the snow vehicle. In the depicted embodiment, the sensor data is generated by a sensor array comprising at least an accelerometer suitable to provide data indicative of whether the snow vehicle is traversing a gradient. In the depicted embodiment, the sensor array may generate 6-dimensional accelerometer data, but other embodiments may comprise other or additional sensor data without deviating from the teachings disclosed herein. At step 708, a slope offset value is generated based upon the sensor data. The slope offset value will be a value of compression or expansion of the body spring that is calculated in response to the gradient of terrain which the snow vehicle is traversing. In the depicted embodiment, the slope offset value may be calculated by a control circuit (such as control circuit 207; see FIG. 2), but other embodiments may generate the slope offset value using an inertial management unit (“IMU”; such as IMU 201; see FIG. 2) without deviating from the teachings disclosed herein. Other embodiments may comprise different configurations without deviating from the teachings disclosed herein.

In the depicted embodiment, a positive slope offset value results from the sensor data indicating that the snow vehicle is traversing a negative gradient (i.e., downhill, or along a decline). In such conditions, the body spring will be compressed, providing a degree of “nose up” rotation of a body of the snow vehicle with respect to its tread. Conversely, a negative slope offset value results from the sensor data indicating that the snow vehicle is traversing a positive gradient (i.e., uphill, or along an incline). In these conditions, the body spring will be expanded, providing a degree of “nose down” rotation of the body of the snow vehicle with respect to the tread. However, these positive/negative correlations may be reversed or altered for snow vehicles having a different orientation or configuration of the body spring.

Erratic and exaggerated slope offset adjustment can create a less comfortable or disorienting experience for a rider of the snow vehicle. In order to avoid this affect, the slope offset value may be set to zero in sufficiently “flat” terrain. In the depicted embodiment, this may be accomplished by only generated a positive or negative slope offset adjustment in response to gradients having an incline/decline above a minimum threshold value. In some such embodiments, the absolute value of the measured slope of the terrain may be compared to the threshold value, and a nonzero slope offset value will only be generated in the event that the absolute value of the slope is greater than the threshold. In the depicted embodiment, the threshold value is a pre-determined threshold, but other embodiments may comprise an adjustable threshold value, including a user-controlled adjustment mechanism-without deviating from the teachings disclosed herein.

In the depicted embodiment, steps 702 and 704 are depicted as being a parallel and concurrent set of operations to steps 706 and 708. In other embodiments in practice, these steps may be performed in any order provided that step 702 precedes step 704 and step 706 performs 708. In some such embodiments, these steps of the method may be performed completely sequentially without deviating from the teachings disclosed herein. In other embodiments, two or more of the steps may be performed partially concurrently without deviating from the teachings disclosed herein. The relative start and completion of each of steps 702 and 704 is independent of the start and completion of steps 706 and 708, and the relative start and completion of each of steps 706 and 708 is likewise independent of the start and completion of steps 702 and 704.

After the completion of each of steps 706 and 708, the method then proceeds to step 710, where the pre-load compression value and the slope offset value are combined to generate a resultant load value to be applied to the body spring. In the depicted embodiment, the resultant load value may be generated using a linear summation of the pre-load compression value and the slope offset value, but other embodiments may utilize a different combination of the values without deviating from the teachings disclosed herein. In some such embodiments, a weighted summation of the values may be utilized without deviating from the teachings disclosed herein. In some embodiments, additional values may be calculated or included in the combination to generate the resultant load value without deviating from the teachings disclosed herein.

After the resultant load value is generated at step 710, the method proceeds to step 712 where the resultant load value is applied to the body spring of the snow vehicle. After the application of the resultant load, the method checks to see if the snow vehicle has ceased operation at step 714. If the snow vehicle has been disengaged, the method ends at step 716. Otherwise, the method returns to a point in the method prior to each of steps 702 and 706 to update the status of the pre-load indicators and sensor data and respond accordingly to changes in the extant operating conditions of the snow vehicle. In the depicted embodiment, this iterative process is performed reactively during operation of the snow vehicle, advantageously providing a response of the snow vehicle in near real-time to changes in extant conditions, and the resultant load is dynamically applied to the body spring responsively to any changes in the pre-load compression value and the slope offset value. Other embodiments may differently iterate or not iterate the method without deviating from the teachings disclosed herein. In some such embodiments, the iteration of the method may be initiated according to a frequency dictated by a timer. In such embodiments, the frequency of update may be a predetermined value, or a user-controlled value via a control mechanism of the snow vehicle, such as a switch or dial. In some such embodiments, the frequency control generates a signal that is utilized by a control circuit (such as control circuit 207) to regulate the speed with which it updates its indicators and adjusts the body spring load compression.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of loading a body spring of a snow vehicle, the method comprising:
generating a pre-load compression value for the body spring based upon the status of a pre-load indicator;
generating a slope signal in response to the output of an accelerometer;
generating a slope offset value based upon the slope signal; and
applying a resultant load to the body spring, the resultant load equaling the combination of the pre-load compression value and the slope offset value.

2. The method of claim 1, wherein the slope offset value is positive in response to the slope signal indicating a motion of the snow vehicle along a negative gradient, the slope offset value is negative in response to the slope signal indicating a motion of the snow vehicle along a positive gradient, and the slope offset is zero in response to the slope signal indicating motion of the snow vehicle on a gradient with an absolute value below a threshold value, and wherein the resultant load equals a sum of the pre-load compression value and the slope offset value.

3. The method of claim 2, wherein the threshold value corresponds to a one-percent gradient.

4. The method of claim 1, wherein the pre-load indicator is determined by the position of a switch.

5. The method of claim 1, wherein the accelerometer is one sensor in a sensor array, and the generating the slope signal is in response to the output of the sensor array.

6. The method of claim 1, wherein pre-load compression value is selected from a plurality of pre-determined values.

7. The method of claim 6, wherein the pre-determined values correspond to pre-loads of 0 bar, 25 bar, and 30 bar of the body spring.

8. The method of claim 1, wherein the method is performed reactively during operation of the snow vehicle, such that the pre-load compression value is generated in response to extant conditions, the slope offset value is generated in response to the extant conditions, and the resultant load is dynamically applied to the body spring responsively to the pre-load compression value and the slope offset value.

9. A control system of a snow vehicle comprising:
a control circuit having a first output to control a braking mechanism of the snow vehicle and a second output to control a load compression of a body spring of the snow vehicle;
an inertial measurement unit having a sensor and in data communication with the control circuit, the inertial measurement unit indicating extant conditions of the snow vehicle;
a pre-load indicator switch indicating a pre-load condition of the body spring; and
a load adjuster configured to apply a compressive load to the body spring in response to a signal from the second output,
wherein the load adjuster applies a compressive load to the body spring responsively to the pre-load condition and extant conditions according to a signal of the second output of the control circuit.

10. The system of claim 9, wherein the sensor is an accelerometer.

11. The system of claim 9, wherein the slope offset value is positive in response to the slope signal indicating a motion of the snow vehicle along a negative gradient, the slope offset value is negative in response to the slope signal indicating a motion of the snow vehicle along a positive gradient, and the slope offset is zero in response to the slope signal indicating motion of the snow vehicle on a gradient with an absolute value below a threshold value.

12. The system of claim 9, wherein the second output is a hydraulic control output.

13. The system of claim 9, wherein the compression state of the body spring further adjusts the attitude of a body of the snow vehicle, the body including a seat for a rider.

14. The system of claim 9, wherein the threshold value corresponds to a one-percent gradient.

15. The system of claim 9, wherein the pre-load compression value is selected from a plurality of pre-determined values.

16. The system of claim 15, wherein the pre-determined values correspond to pre-loads of 0 bar, 25 bar, and 30 bar of the body spring.

17. The system of claim 9, wherein the control circuit comprises a digital circuit.

18. The system of claim 9, wherein the inertial measurement unit comprises a digital circuit.

19. A control system of a snow vehicle comprising:
a control circuit having an output to control a pre-load compression of a body spring of the snow vehicle;
an inertial measurement unit having a sensor and in data communication with the control circuit, the inertial measurement unit indicating extant conditions of the snow vehicle;
a pre-load indicator switch indicating a pre-load condition of the body spring; and
a load adjuster configured to apply a compressive load to the body spring in response to a signal from the output,
wherein the load adjuster applies a compressive load to the body spring responsively to the pre-load condition and the extant conditions according to a signal of the output of the control circuit.

20. The control system of claim 19, wherein the output is a hydraulic control output.
